(19) United States
(12) Patent Application Publication
(10) Pub. No.: US 2026/0277823 A1
(43) Pub. Date: Sep. 17, 2026

(54) Elastic In-Memory Caching

(71) Applicant: Google LLC, Mountain View, CA (US)

(72) Inventors: Manish Purohit, Fremont, CA (US); Tamás Sarlós, Cupertino, CA (US); Shanmugasundaram Ravikumar, Piedmont, CA (US); Todd Johnson Lipcon, Menlo Park, CA (US)

(21) Appl. No.: 19/079,589

(22) Filed: Mar. 14, 2025

(51) Int. Cl. G06F 12/121

(52) U.S. Cl. CPC G06F 12/121

(57) ABSTRACT

Aspects of the disclosure are directed to a cache maintenance policy that reduces the total cost incurred by the cache, including the storage cost to maintain data in the cache and any costs associated with fetching requested data that is no longer in the cache. The cache maintenance policy uses a machine learning model to determine a time-to-live (TTL) for data based on access patterns and associated costs. Integrating the cache maintenance policy with a cache eviction policy results in reducing total cost to maintain the cache, particularly compared to fixed-size cache policies.

### BACKGROUND

In-memory caching is a technique for achieving higher performance in database management systems and cloud services. By storing frequently accessed data in a memory cache, costly disk input/output operations can be reduced and latency to access data can be improved. However, caching the data in-memory can still be expensive, as there is typically a storage cost to maintain the data in the memory cache. Therefore, caches can be provisioned based on a peak demand to account for the high cost, which assume fixed memory resources and focus on eviction policies to minimize requested data not being in the cache. However, statically allocating memory to meet the peak demand and focusing on eviction policies can result in significant resource underutilization, particularly in bursty workloads.

### BRIEF SUMMARY

Aspects of the disclosure are directed to a cache maintenance policy that reduces the total cost incurred by the cache, including the storage cost to maintain data entries in the cache and any costs associated with fetching requested data entries that are no longer in the cache. Storage costs for maintaining entries can refer to memory amounts, e.g., bytes, integrated over time. Costs associated with fetching requested data entries can refer to latency, network transfer, disk access, re-computation, and/or memory read costs from fetching the entry that is no longer in the cache. The cache maintenance policy uses a machine learning model to determine a time-to-live (TTL) for each data entry based on access patterns and associated costs. Integrating the cache maintenance policy with a cache eviction policy results in reducing total cost to maintain the cache, particularly compared to fixed-size cache policies.

An aspect of the disclosure provides for a method for elastic memory caching including: receiving, by one or more processors, a first request for a first entry in a cache; determining, by the one or more processors, a first time-to-live for the first entry based on a cache maintenance policy associated with a machine learning model trained to output time-to-live based on a cost to maintain entries in the cache and a cost to evict entries from the cache; receiving, by the one or more processors, at a time before the first time-to-live, a second request for the first entry in the cache; determining, by the one or more processors, a second time-to-live for the first entry based on the cache maintenance policy; and evicting, by the one or more processors, the first entry at a time equal to or after the second time-to-live.

Another aspect of the disclosure provides for a system including: one or more processors; and one or more storage devices coupled to the one or more processors and storing instructions that, when executed by the one or more processors, cause the one or more processors to perform operations for the method for elastic memory caching. Yet another aspect of the disclosure provides for a non-transitory computer readable medium for storing instructions that, when executed by one or more processors, cause the one or more processors to perform operations for the method for elastic memory caching.

In some examples, the machine learning model outputs the first time-to-live and the second time-to-live from the cost to maintain entries in the cache and the cost to evict entries from the cache. In some examples, the machine learning model outputs a scalar value from the cost to maintain entries in the cache and cost to evict entries from the cache; and the first time-to-live and the second time-to-live are determined from the scalar value multiplied by a breakeven value.

In some examples, the cache maintenance policy is associated with at least one of a breakeven policy or a randomized policy. In some examples, the request is a read request or a write request. In some examples, the entry is a memory page in the cache.

In some examples, the method further includes: receiving, by the one or more processors, a request for a second entry in the cache; determining, by the one or more processors, that the second entry is not in the cache and that the cache is full; and evicting, by the one or more processors, a third entry from the cache based on a cache eviction policy. In some examples, the cache eviction policy includes at least one of a least recently used policy, a least frequently used policy, a least frequently used with dynamic aging policy, or a greedy dual size frequency policy.

In some examples, the machine learning model is trained to minimize a total cost of the cost to maintain entries in the cache and the cost to evict entries from the cache subject to a capacity constraint. In some examples, the machine learning model is trained using training examples derived from a trace of the cache.

### BRIEF DESCRIPTION OF THE DRAWINGS

FIG. 1 depicts a block diagram of an example storage system implementing an elastic memory cache according to aspects of the disclosure.

FIG. 2 depicts a block diagram of an example elastic memory caching system according to aspects of the disclosure.

FIG. 3 depicts a block diagram of an example environment implementing the elastic memory caching system according to aspects of the disclosure.

FIG. 4 depicts a block diagram of one or more machine learning model architectures according to aspects of the disclosure.

FIG. 5 depicts a flow diagram of an example process for elastic memory caching according to aspects of the disclosure.

FIG. 6 depicts a flow diagram of an example process for elastic memory cache eviction according to aspects of the disclosure.

### DETAILED DESCRIPTION

The technology relates generally to an elastic memory caching approach for reducing costs incurred by the cache, such as storage costs of maintaining entries in the cache and costs associated with any cache misses, e.g., a requested entry is not in the cache. Entries can refer to memory pages, as an example. Storage costs for maintaining entries can refer to memory amounts, e.g., bytes, integrated over time. Costs associated with cache misses can refer to latency, network transfer, disk access, re-computation, and/or memory read costs from fetching the entry that is no longer in the cache. The approach determines a time-to-live (TTL) for each cached entry based on its access patterns and associated costs. The approach can significantly reduce cache costs compared to alternative fixed-size cache approaches.

The approach integrates cache maintenance policies with cache eviction policies. Cache maintenance policies refer to policies that strike a balance between the cost of cache misses and the cost of maintaining the cache over time. For example, for each entry in the cache, there is a cost to hold that entry in the cache for a period of time and a cost incurred due to a miss for the entry if entry is evicted. A total cost can be the sum of those costs over time for all resident entries in the cache and all entries evicted. The cache maintenance policy can minimize this total cost subject to a peak capacity constraint. Example cache maintenance policies include a breakeven policy and/or a randomized policy. The breakeven policy can refer to evicting an entry at a time when the cumulative cost to maintain the entry is equal to or greater than the cost to evict the entry. The randomized policy can refer to evicting an entry at a random time based on a predetermined distribution, such as a distribution resulting in an expected cost that is e/(e−1) times worse than a policy with perfect future knowledge. Cache eviction policies refer to policies that determine which entries to evict from the cache when the cache is full and space is needed to insert a new entry. Example cache eviction policies include a least recently used policy, a least frequently used policy, a least frequently used with dynamic aging policy that applies a time bias to the least frequently used policy, or a greedy dual size frequency policy that accounts for size in the least frequently used policy.

An entry request can be received for the cache. The request can be a read or write request for an entry in the cache. A TTL is determined for the entry based on the cache maintenance policy. The TTL can be determined using a machine learning model trained to output a TTL based on features, such as domain features, cost to maintain entries, and cost to evict entries. Domain features can include entry type, amount of time in the cache, and/or operation that resulted in the entry in the cache, e.g., user request or a maintenance request. The machine learning model can directly map to the TTL based on the features or can map a scalar based on the features and determine the TTL by multiplying the scalar with the breakeven value. The machine learning model can be trained using training examples derived from a trace of the cache. The entry thus gets evicted from the cache at its TTL unless it is requested again before that time, at which the TTL is determined again via the cache maintenance policy. If the requested entry is not in the cache and the cache is full, one or more entries in the cache get evicted based on the cache eviction policy.

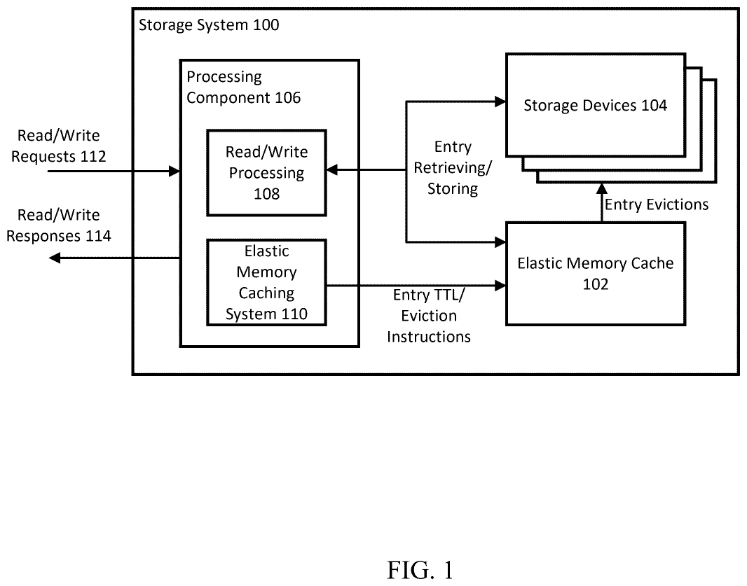

FIG. 1 depicts a block diagram of an example storage system 100 implementing an elastic memory cache 102. The storage system 100 can be implemented in one or more computing devices in one or more locations. The storage system can form part of a cloud computing system for cloud computing services, such as Infrastructure as a Service (IaaS), Platform as a Service (PaaS), and/or Software as a Service (SaaS). For example, the cloud computing system may provide software applications, such as accounting, word processing, inventory tracking, fraud detection, file sharing, video sharing, audio sharing, communication, and/or gaming. The storage system 100 can include the elastic memory cache 102, a plurality of storage devices 104, and a processing component 106.

The elastic memory cache 102 can store more frequently accessed data entries, as the cache allows the data entries to be accessed faster than the storage devices 104. The elastic memory cache 102 can be any form of computer memory placed in close proximity to the processing component 106 for faster access times. While shown as a separate component, the elastic memory cache 102 can be part of the processing component 106. There can be multiple levels of the elastic memory cache 102, e.g., level 2 and/or level 3 cache layers, and the elastic memory cache 102 can have a variable size.

The storage devices 104 can store less frequently accessed data entries, as data entries stored in the storage devices 104 are accessed more slowly than the elastic memory cache 102. The storage devices 104 be any device suitable for storing computer readable data. The storage devices 104 may also be their own storage system having their own processing components, allowing for tiered or layered caching in the storage system 100. The storage devices 104 can be a device with fixed storage or a device for reading removable storage media. Examples include all forms of non-volatile memory, media and memory devices, semiconductor memory devices, e.g., erasable programmable read-only memory (EPROM), electrically EPROM (EEPROM), SDRAM, and flash memory devices, magnetic disks, magneto-optical disks, and optical discs. The storage system 100 can have any number of storage devices 104.

The processing component 106 can be any logic circuitry that executes instructions to process data requests and manage the elastic memory cache 102. The processor component 106 can include microprocessor units or special purpose processor units. The processing component 106 can be single core or multi-core processors or multiple distinct processors. The processing component 106 can be implemented as circuitry on one or more chips. The processing component 106 can include central processing units (CPUs), graphic processing units (GPUs), field-programmable gate arrays (FPGAs), and/or application-specific integrated circuits (ASICs), such as tensor processing units (TPUs), as examples.

The processing component 106 can include a read/write processing element 108 and an elastic memory caching system 110. The read/write processing element 108 can be configured to process data requests, such as read and/or write requests 112. The read/write processing element 108 can receive a read or write request 112 for a data entry and process the read or write request 112 to generate a read or write response 114. For read requests, the read/write processing element 108 can receive a read request for a data entry, fetch the data entry from the elastic memory cache 102 or the storage devices 104, and output the data entry as a read response. For write requests, the read/write processing element 108 can receive a write request for a data entry, write the data entry in the elastic memory cache 102 or the storage devices 104, and output a write response confirming the data entry was written.

The elastic memory caching system 110 can be configured to manage data entries in the elastic memory cache 102. The elastic memory caching system 110 can be configured to determine which data entries to maintain in the elastic memory cache 102 and which entries to evict to the storage devices 104 when the cache size is variable. The elastic memory caching system 110 can balance the cost of maintaining data entries in the elastic memory cache 102 over time with costs incurred to retrieve any data entries from the storage devices 104. The elastic memory caching system 110 can determine a time-to-live (TTL) for any entries in the elastic memory cache 102 using a machine learning model based on the cost to maintain the entries with a cost to evict the entries. The TTL for an entry indicates how long the entry stays in the elastic memory cache 102. The elastic memory caching system 110 can evict entries from the elastic memory cache 102 at their TTL, unless they are requested again before the TTL, at which point the elastic memory caching system 110 can determine the TTL again. The elastic memory caching system 110 can also evict entries from the cache if a requested entry is not in the cache and the cache is full. While FIG. 1 depicts entry eviction as returning to the storage devices 104, alternatively or additionally, entry eviction can include evicting entries to other storage devices outside the storage system 100 and/or deleting the evicted entries.

Below is an example process for managing data entries in the elastic memory cache 102.

Input: Eviction Policy A, Cache Maintenance Policy M
C ← 0;
for time t = 1,2, ..., do
/* Evict any pages whose TTLs have expired */
for entry p ∈ C do: if ttl(p) < t then Evict p from C;
/* Process page requested at time t if any */
if page pₜ is requested at time t then send pₜ to A;
maintain time ← M(pₜ); ttl(pₜ) ← t +
maintain time.

Maintain time refers the time duration for which the cache maintenance policy M recommends holding pt in the elastic memory cache 102.

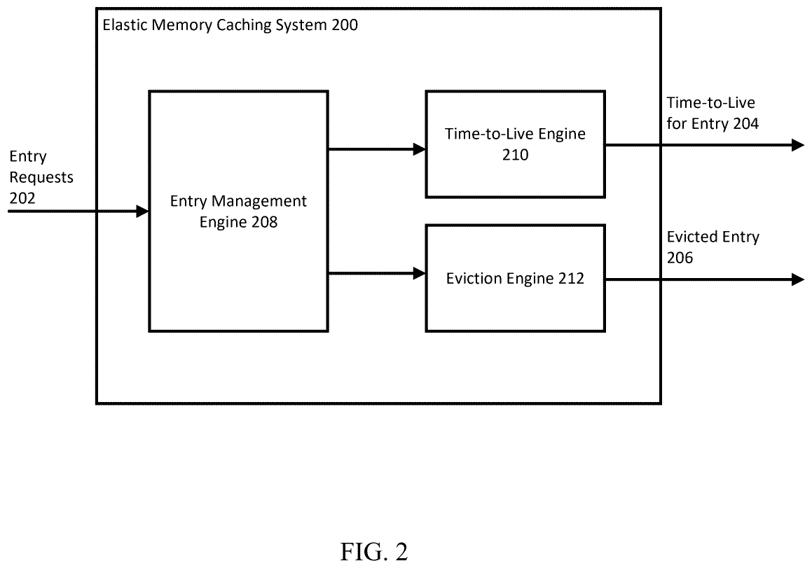

FIG. 2 depicts a block diagram of an example elastic memory caching system 200 according to aspects of the disclosure. The elastic memory caching system 200 can be implemented in one or more computing devices in one or more locations. The elastic memory caching system 200 can correspond to the elastic memory caching system 110 as depicted in FIG. 1.

The elastic memory caching system 200 can be configured to receive input data, including entry requests 202. The entry requests 202 can include read and/or write requests for entries in the elastic memory cache. Read requests can refer to retrieving data from the elastic memory cache. Write requests can refer to storing data in the elastic memory cache. For example, the elastic memory caching system 200 can receive the input data as part of a call to an application programming interface (API) exposing the elastic memory caching system 200 to one or more computing devices. The elastic memory caching system 200 can also receive the input data through a storage medium, such as remote storage connected to one or more computing devices over a network. The elastic memory caching system 200 can further receive the input data through a user interface on a client computing device coupled to the elastic memory caching system 200.

Based on the entry requests 202, the elastic memory caching system 200 can output a TTL 204 for the entry and/or evict another entry 206 from the elastic memory cache. The TTL 204 can refer to how long the entry stays in the elastic memory cache without being accessed again. The eviction 206 can refer to removing an entry from the elastic memory cache and/or moving the entry to another storage device.

As an example, the elastic memory caching system 200 can be configured to send the TTL data 204 and/or eviction data 206 for display on a client or user display. As another example, the elastic memory caching system 200 can be configured to provide the TTL data 204 and/or eviction data 206 as a set of computer-readable instructions, such as one or more computer programs for maintaining entries and/or evicting entries from the elastic memory cache. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The elastic memory caching system 200 can further be configured to forward the TTL data 204 and/or eviction data 206 to one or more other devices configured for translating the data for display or into an executable program written in a computer programming language for maintaining entries and/or evicting entries from the elastic memory cache. The elastic memory caching system 200 can also be configured to send the TTL data 204 and/or eviction data 206 to a storage device for storage and later retrieval.

The elastic memory caching system 200 can include an entry management engine 208, a time-to-live engine 210, and an eviction engine 212. The entry management engine 208, time-to-live engine 210, and eviction engine 212 can be implemented as one or more computer programs, specially configured electronic circuitry, or any combination thereof.

The entry management engine 208 can be configured to determine whether to utilize a cache maintenance policy or cache eviction policy for received entry requests 202. Cache maintenance policies refer to policies that balance the cost of cache misses with the cost of maintaining the elastic memory cache over time while cache eviction policies refer to policies that determine which entries to evict from the elastic memory cache. The entry management engine 208 can determine whether the entry request 202 is already in the elastic memory cache. If the entry request 202 is in the elastic memory cache, entry management engine 208 transmits the entry request 202 to the time-to-live engine 210 to determine a TTL for the entry request 202. If the entry request 202 is not in the elastic memory cache, the entry management engine 208 can determine whether the elastic memory cache has space for the entry request 202, e.g., whether the elastic memory cache is full. If the elastic memory cache has space for the entry request 202, the entry management engine 208 transmits the entry request 202 to the time-to-live engine 210 to determine a TTL for the entry request 202. If the elastic memory cache does not have space for the entry request 202, the entry management engine 208 still transmits the entry request 202 to the time-to-live engine 210 to determine a TTL for the entry request 202 while also transmitting an instruction to the eviction engine 212 to determine an entry in the elastic memory cache to evict to make space for the entry request 202 in the elastic memory cache.

The time-to-live engine 210 can be configured to determine a TTL for entry requests 202 based on one or more cache maintenance policies. The cache maintenance policy can minimize or otherwise reduce a total cost including a cost for holding entries in the elastic memory cache over a period of time and a one-time cost for when an entry is requested but is missing from the elastic memory cache. The total cost may also be subject to a peak capacity constraint for the elastic memory cache. The time-to-live engine 210 can implement a breakeven cache maintenance policy and/or a randomized cache maintenance policy, as examples. The breakeven policy can refer to evicting an entry at a time when the cumulative cost to maintain the entry is equal to or greater than the cost to evict the entry. The randomized policy can refer to evicting an entry at a random time based on a predetermined distribution.

The time-to-live engine 210 can use a machine learning model to determine the TTL for the entry requests 202. The machine learning model can be trained to output the TTL for each entry request 202 based on domain features of the entry request 202, the cost to hold entry request 202 in the elastic memory cache over time, and the cost to retrieve the entry request 202 if the entry request is no longer in the elastic memory cache. Domain features can refer features about the entry requests 202 that can influence the TTL. Example domain features include entry type, entry size, amount of time already in the elastic memory cache, and/or operation that resulted in the entry in the elastic memory cache, such as whether entry request 202 is a user request or a maintenance request. The machine learning model can be trained and/or validated using historical training examples derived from a trace of the elastic memory cache. The trace of the elastic memory cache can refer to a historical record of which entries were stored in the elastic memory cache, how long they were stored in the elastic memory cache, and what their associated costs were to be stored and/or evicted from the elastic memory cache. The machine learning model can map the TTL for the entry request 202 to the features and costs of the entry request 202 or can map a scalar value to the features and costs of the entry request 202 and determine the TTL of the entry request 202 by multiplying the scalar value with a breakeven value. The breakeven value is the value when the cumulative cost to maintain the entry request 202 over a period of time is equal to or greater than the one-time cost to evict the entry request 202.

The eviction engine 212 can be configured to determine one or more entries to evict from the elastic memory cache based on TTLs expiring or one or more eviction policies. Example cache eviction policies include a least recently used policy, a least frequently used policy, a least frequently used with dynamic aging policy, and/or a greedy dual size frequency policy. For the least recently used policy, the eviction engine 212 can maintain a list of entries in the order of most recent to least recent access. The eviction engine 212 can evict one or more entries that were accessed less recently. For the least frequently used policy, the eviction engine 212 can maintain a list of entries in the order of most frequent to least frequent access. The eviction engine 212 can evict one or more entries that were accessed less frequently. For the least frequently used with dynamic aging policy, the eviction engine 212 can maintain a list of entries in the order of most frequent to least frequent access, where the entries are weighted based on how recently they were accessed. The eviction engine 212 can evict one or more entries that were accessed less frequently, when accounting for the recency weighting. For the greedy dual size frequency policy, the eviction engine 212 can maintain a list of entries in the order of most frequent to least frequent access, where the entries are weighted based on their size. The eviction engine 212 can evict one or more entries that were accessed less frequently, when accounting for the size weighting.

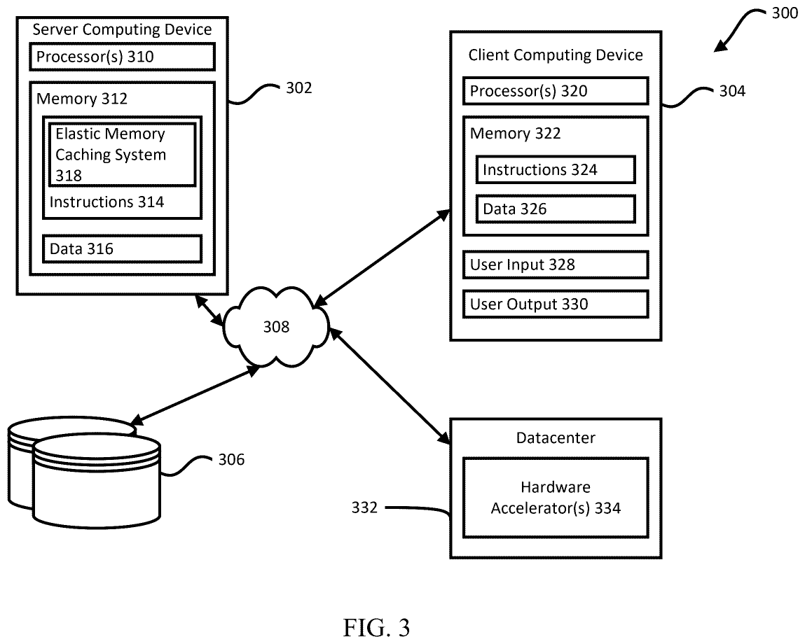

FIG. 3 depicts a block diagram of an example environment 300 for implementing an elastic memory caching system 318. The elastic memory caching system 318 can be implemented on one or more devices having one or more processors in one or more locations, such as in server computing device 302. A client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors 310 to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing the elastic memory caching system 318, which can correspond to the elastic memory caching system 200 as depicted in FIG. 2. The elastic memory caching system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the respective computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions 314, 324 and data 316, 326 can be stored in a location physically remote from, yet still accessible by, the processors 310, 320. Similarly, the processors 310, 320 can include a collection of processors that can perform concurrent and/or sequential operations. The computing devices 302, 304 can each include one or more internal clocks providing timing information, which can be used for time measurement for operations and programs run by the computing devices 302, 304.

The server computing device 302 can be connected over the network 308 to a data center 332 housing any number of hardware accelerators 334. The data center 332 can be one of multiple data centers or other facilities in which various types of computing devices, such as hardware accelerators, are located. Computing resources housed in the data center 332 can be specified for deploying models, such as for determining TTL, as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. The client computing device 304 can transmit input data as part of a query for a task involving a read or write request. The elastic memory caching system 318 can receive the input data, and in response, generate output data including a response to the query including a read or write response.

The server computing device 302 can maintain a variety of models in accordance with different constraints available at the data center 332. For example, the server computing device 302 can maintain different families for deploying models on various types of TPUs and/or GPUs housed in the data center 332 or otherwise available for processing.

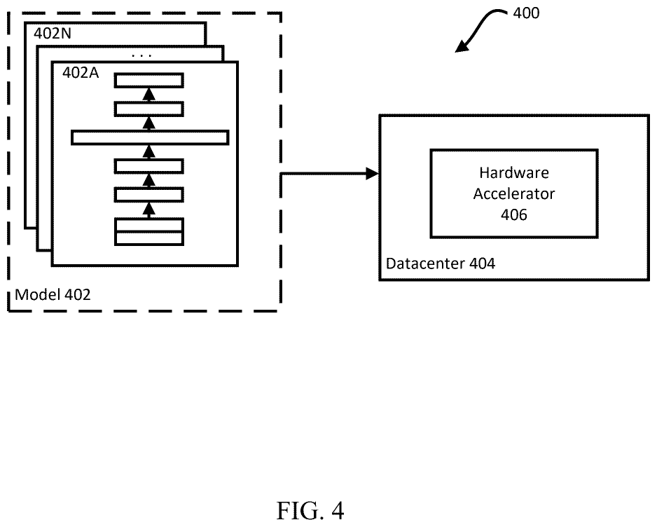

FIG. 4 depicts a block diagram 400 illustrating one or more machine learning model architectures 402 according to aspects of the disclosure. More specifically, FIG. 4 depicts architectures 402A-N for deployment in a datacenter 404 housing a hardware accelerator 406 on which the deployed machine learning models 402 will execute, such as for the variety of services as described herein. The hardware accelerator 406 can be any type of processor, such as a CPU, GPU, FPGA, or ASIC such as a TPU.

An architecture 402 of a machine learning model can refer to characteristics defining the model, such as characteristics of layers for the model, how the layers process input, or how the layers interact with one another. The architecture 402 of the machine learning model can also define types of operations performed within each layer. One or more machine learning model architectures 402 can be generated that can output results involving determining TTL. Example model architectures 402 can correspond to lightweight models that are designed to be smaller in size and function with reduced computational power.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

Referring back to FIG. 3, the devices 302, 304 and the data center 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 can include various configurations and protocols including the Internet, World Wide Web, intranets, virtual private networks, wide area networks, local networks, and private networks using communication protocols proprietary to one or more companies. The network 308 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

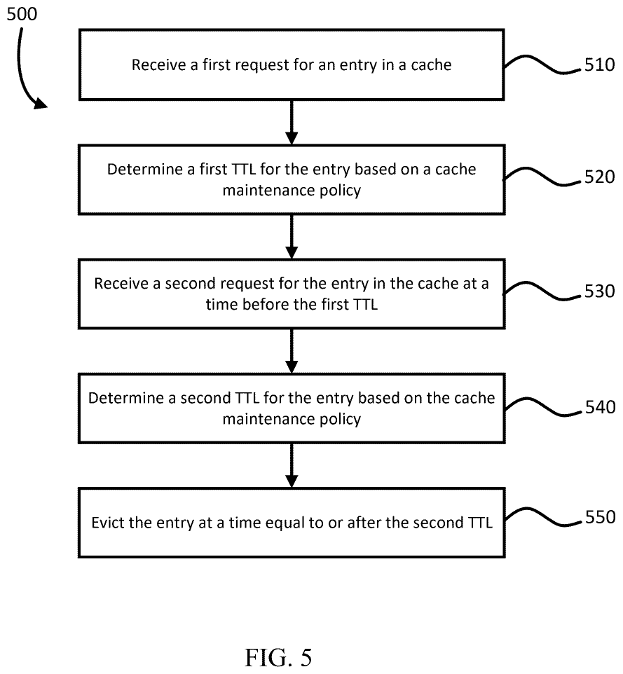

Although a single server computing device 302, client computing device 304, storage device 306, and data center 332 are shown in FIG. 5, it is understood that aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

FIG. 5 depicts a flow diagram of an example process 500 for elastic memory cache maintenance. The example process 500 can be performed on a system of one or more processors in one or more locations, such as the elastic memory caching system 200 as depicted in FIG. 2.

As shown in block 510, the elastic memory caching system 200 receives a first request for an entry in a cache. The request can be a read request or a write request. The cache can be an in-memory cache, and the entry can be a memory page in the cache.

As shown in block 520, the elastic memory caching system 200 determines a first TTL for the entry based on a cache maintenance policy. The cache maintenance policy can be associated with a breakeven policy and/or a randomized policy. The cache maintenance policy can be associated with a machine learning model trained to output TTL based on a cost to maintain entries in the cache and a cost to evict entries from the cache. The machine learning model can be trained to output TTL further based on domain features, such as entry type, entry size, time in the cache, and/or request operation. The machine learning model can be trained to minimize a total cost of the cost to maintain entries in the cache and the cost to evict entries from the cache subject to a capacity constraint. The machine learning model can be trained using training examples derived from a trace of the cache.

As shown in block 530, the elastic memory caching system 200 receives a second request for the entry in the cache at a time before the first TTL.

As shown in block 540, the elastic memory caching system 200 determines a second TTL for the entry based on the cache maintenance policy. The machine learning model can output the first TTL and the second TTL from the cost to maintain entries in the cache and the cost to evict entries from the cache. Alternatively, or additionally, the machine learning model can output a scalar value from the cost to maintain entries in the cache and the cost to evict entries from the cache. The elastic memory caching system 200 can determine the first TTL and the second TTL from the scalar value multiplied by a breakeven value.

As shown in block 550, the elastic memory caching system 200 evicts the first entry at a time equal to or after the second TTL.

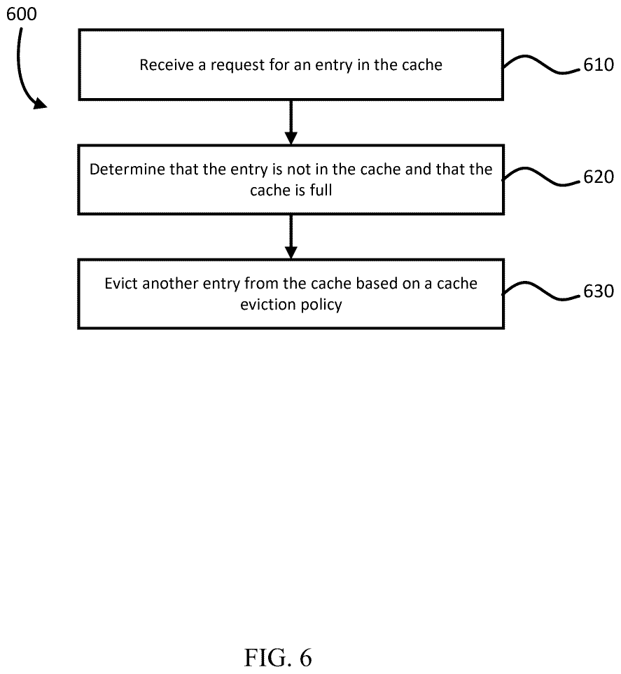

FIG. 6 depicts a flow diagram of an example process 600 for elastic memory cache eviction. The example process 600 can be performed on a system of one or more processors in one or more locations, such as the elastic memory caching system 200 as depicted in FIG. 2.

As shown in block 610, the elastic memory caching system 200 receives a request for an entry in a cache. The request can be a read request or a write request. The cache can be an in-memory cache, and the entry can be a memory page in the cache.

As shown in block 620, the elastic memory caching system 200 determines that the requested entry is not in the cache and that the cache is full or otherwise does not have the capacity to store the requested entry.

As shown in block 630, the elastic memory caching system 200 evicts another entry from the cache based on a cache eviction policy. The cache eviction policy can be a least recently used policy, a least frequently used policy, a least frequently used with dynamic aging policy, or a greedy dual size frequency policy, as examples.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for elastic memory caching comprising:
receiving, by one or more processors, a first request for a first entry in a cache;
determining, by the one or more processors, a first time-to-live for the first entry based on a cache maintenance policy associated with a machine learning model trained to output time-to-live based on a cost to maintain entries in the cache and a cost to evict entries from the cache;
receiving, by the one or more processors, at a time before the first time-to-live, a second request for the first entry in the cache;
determining, by the one or more processors, a second time-to-live for the first entry based on the cache maintenance policy; and
evicting, by the one or more processors, the first entry at a time equal to or after the second time-to-live;
wherein:
the machine learning model outputs a cost value from the cost to maintain entries in the cache and the cost to evict entries from the cache; and
the first time-to-live and the second time-to-live are determined from respective cost values multiplied by a breakeven value.

2. The method of claim 1, wherein the machine learning model outputs the first time-to-live and the second time-to-live from the cost to maintain entries in the cache and the cost to evict entries from the cache.

3. The method of claim 1, wherein the respective cost values and the breakeven value are scalar values.

4. The method of claim 1, wherein the cache maintenance policy is associated with at least one of a breakeven policy or a randomized policy.

5. The method of claim 1, wherein the request is a read request or a write request.

6. The method of claim 1, wherein the entry is a memory page in the cache.

7. The method of claim 1, further comprising:
receiving, by the one or more processors, a request for a second entry in the cache;
determining, by the one or more processors, that the second entry is not in the cache and that the cache is full; and
evicting, by the one or more processors, a third entry from the cache based on a cache eviction policy.

8. The method of claim 7, wherein the cache eviction policy comprises at least one of a least recently used policy, a least frequently used policy, a least frequently used with dynamic aging policy, or a greedy dual size frequency policy.

9. The method of claim 1, wherein the machine learning model is trained to minimize the cost value from the cost to maintain entries in the cache and the cost to evict entries from the cache subject to a capacity constraint.

10. The method of claim 1, wherein the machine learning model is trained using training examples derived from a trace of the cache.

11. A system comprising:
one or more processors; and
one or more storage devices coupled to the one or more processors and storing instructions that, when executed by the one or more processors, cause the one or more processors to perform operations for elastic memory caching, the operations comprising:
receiving a first request for a first entry in a cache;
determining a first time-to-live for the first entry based on a cache maintenance policy associated with a machine learning model trained to output time-to-live based on a cost to maintain entries in the cache and a cost to evict entries from the cache;
receiving, at a time before the first time-to-live, a second request for the first entry in the cache;
determining a second time-to-live for the first entry based on the cache maintenance policy; and
evicting the first entry at a time equal to or after the second time-to-lives
wherein:
the machine learning model outputs a cost value from the cost to maintain entries in the cache and the cost to evict entries from the cache; and
the first time-to-live and the second time-to-live are determined from respective cost values multiplied by a breakeven value.

12. The system of claim 11, wherein the machine learning model outputs the first time-to-live and the second time-to-live from the cost to maintain entries in the cache and the cost to evict entries from the cache.

13. The system of claim 11, wherein the respective cost values and the breakeven value are scalar values.

14. The system of claim 11, wherein the cache maintenance policy is associated with at least one of a breakeven policy or a randomized policy.

15. The system of claim 11, wherein the operations further comprise:
receiving a request for a second entry in the cache;
determining that the second entry is not in the cache and that the cache is full; and
evicting a third entry from the cache based on a cache eviction policy.

16. The system of claim 15, wherein the cache eviction policy comprises at least one of a least recently used policy, a least frequently used policy, a least frequently used with dynamic aging policy, or a greedy dual size frequency policy.

17. The system of claim 11, wherein the machine learning model is trained to minimize the cost value from the cost to maintain entries in the cache and the cost to evict entries from the cache subject to a capacity constraint.

18. The system of claim 11, wherein the machine learning model is trained using training examples derived from a trace of the cache.

19. A non-transitory computer readable medium for storing instructions that, when executed by one or more processors, cause the one or more processors to perform operations for elastic memory caching, the operations comprising:
receiving a first request for a first entry in a cache;
determining a first time-to-live for the first entry based on a cache maintenance policy associated with a machine learning model trained to output time-to-live based on a cost to maintain entries in the cache and a cost to evict entries from the cache;
receiving, at a time before the first time-to-live, a second request for the first entry in the cache;
determining a second time-to-live for the first entry based on the cache maintenance policy; and
evicting the first entry at a time equal to or after the second time-to-live;
wherein:
the machine learning model outputs a cost value from the cost to maintain entries in the cache and the cost to evict entries from the cache; and
the first time-to-live and the second time-to-live are determined from respective cost values multiplied by a breakeven value.

20. The non-transitory computer readable medium of claim 19, wherein the operations further comprise:
receiving a request for a second entry in the cache;
determining that the second entry is not in the cache and that the cache is full; and evicting a third entry from the cache based on a cache eviction policy.
